(19) United States
(12) Patent Application Publication
(10) Pub. No.: US 2018/0050738 A1
(43) Pub. Date: Feb. 22, 2018

(54) Pickup truck having a folding rail structure

(71) Applicant: Tsung-En Lee, Taichung (TW)

(72) Inventor: Tsung-En Lee, Taichung (TW)

(21) Appl. No.: 15/795,308

(22) Filed: Oct. 27, 2017

(51) Int. Cl. B62D 33/02; B60R 21/13; B60P 3/40; B60R 3/00

(52) U.S. Cl. CPC B62D 33/0207; B60R 21/13; B62D 33/0273; B60R 3/007; B60P 3/40

(57) ABSTRACT

A pickup truck is provided with a cab; a tailgate; a bed; two side walls; two sets of locking assemblies disposed on the side walls respectively; and a folding ladder including two side rails, a plurality of rungs, a first section at a first end, a second section at a second end, a third section between the first section and the second section, and a plurality of one-way hinges each disposed at one of two joining portions of the first section and the third section or one of two joining portions of the second section and the third section. The locking assembly includes a tubular member for allowing the side rail to pass through, a concave keeper surface disposed on the tubular member, and a cam type actuator arm configured to pivotably engage the concave keeper surface to fasten the side rail and the tubular member together.

### BACKGROUND OF THE INVENTION

### 1. Field of the Invention

The invention relates to pickup trucks and more particularly to a pickup truck having a folding rail structure.

### 2. Description of Related Art

Conventionally, a pickup truck has a bed for carrying loads. Further, some pickup trucks have an anti-roll cage. However, it is fixed and has a single function. Thus, the need for improvement still exists.

### SUMMARY OF THE INVENTION

It is therefore one object of the invention to provide a pickup truck comprising a cab; a tailgate; a bed; two side walls; two sets of a plurality of locking assemblies disposed on the side walls respectively; and a folding ladder including two side rails, a plurality of rungs, a first section at a first end, a second section at a second end, a third section between the first section and the second section, and a plurality of one-way hinges each disposed at one of two joining portions of the first section and the third section or one of two joining portions of the second section and the third section; wherein each locking assembly includes a tubular member for allowing either side rail of the folding ladder to pass through, a concave keeper surface disposed on the tubular member, and a cam type actuator arm configured to pivotably engage the concave keeper surface to fasten the side rail of the folding ladder and the tubular member together.

The above and other objects, features and advantages of the invention will become apparent from the following detailed description taken with the accompanying drawings.

### BRIEF DESCRIPTION OF THE DRAWINGS

FIG. 1 is a perspective view of a pickup truck according to the invention;

FIG. 2 is a side elevation of the pickup truck of FIG. 1;

FIG. 3 is a perspective view of the pickup truck showing a first configuration of the folding ladder;

FIG. 4 is a side elevation of the pickup truck of FIG. 3;

FIG. 5 is a perspective view of the pickup truck showing a second configuration of the folding ladder;

FIG. 6 is a side elevation of the pickup truck of FIG. 5;

FIG. 7 is an enlarged view of the locking assembly;

FIG. 8 is an enlarged view of the hinge and surrounding components;

FIG. 9 is a perspective view of the pickup truck showing a third configuration of the folding ladder;

FIG. 10 is a perspective view of the pickup truck showing a fourth configuration of the folding ladder; and

FIG. 11 is a perspective view of the pickup truck showing a fifth configuration of the folding ladder.

### DETAILED DESCRIPTION OF THE INVENTION

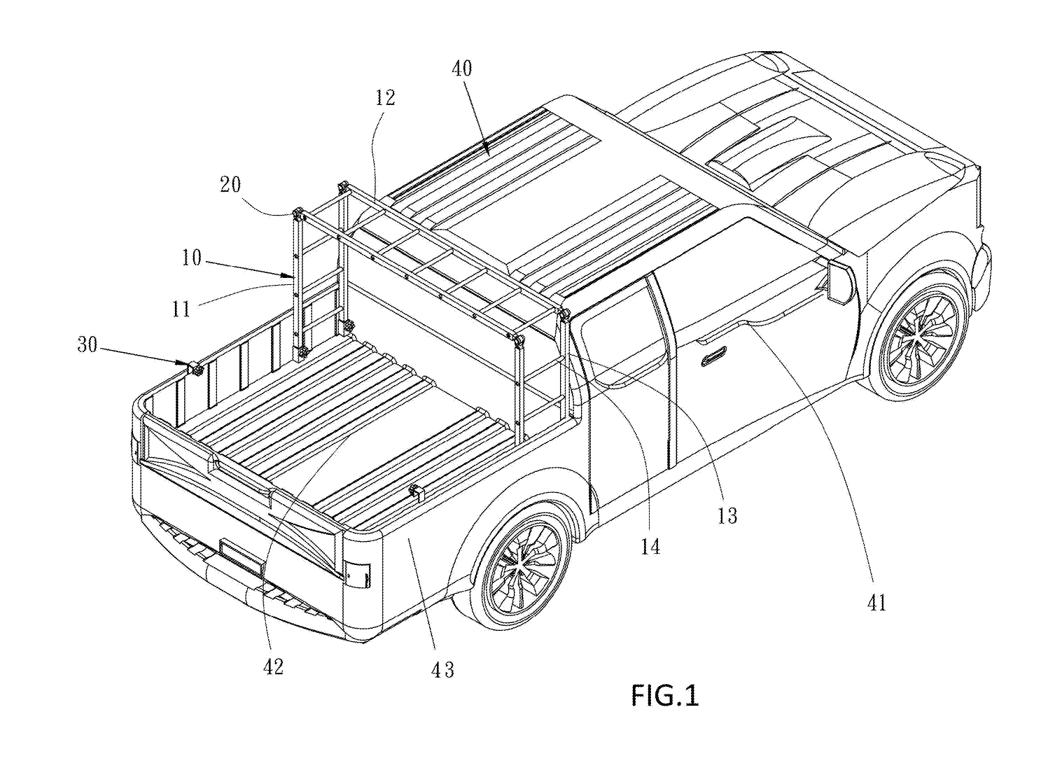

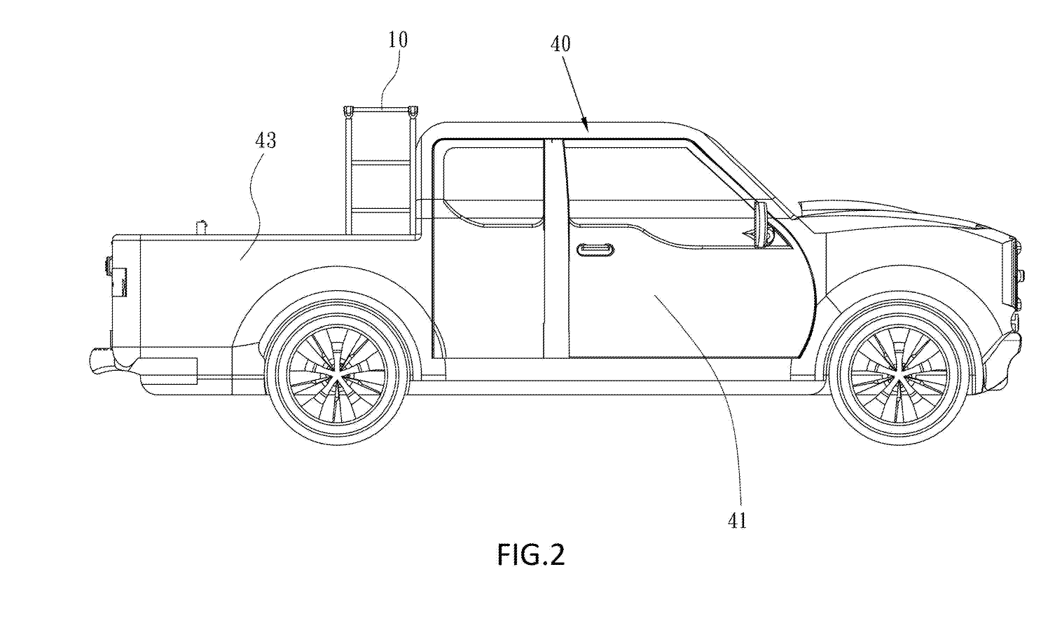

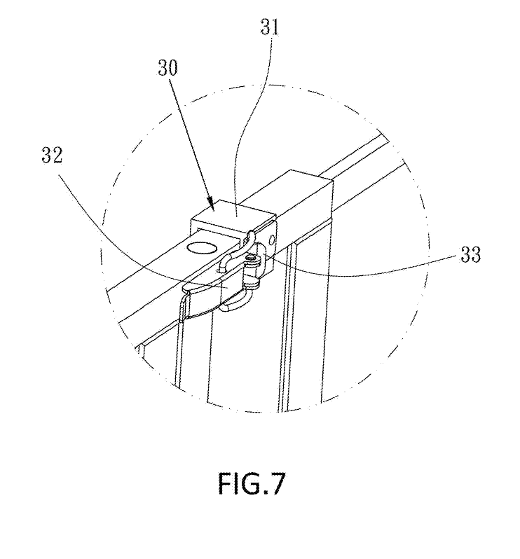

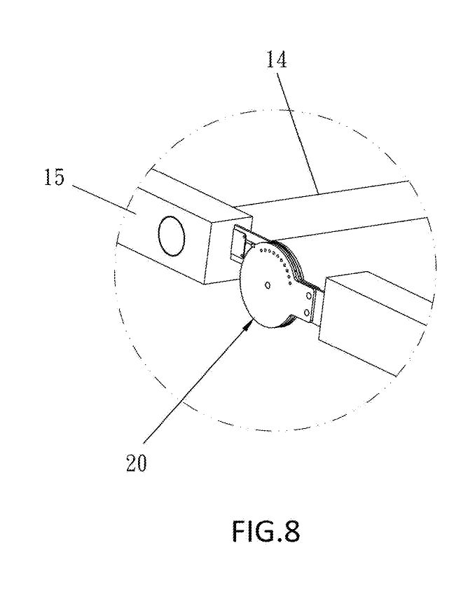

Referring to FIGS. 1 to 11, a pickup truck 40 in accordance with the invention comprises a cab 41, a tailgate 421, a bed 42, two side walls 43, two sets of a plurality of locking assemblies 30 on the side walls 43 respectively, a plurality of one-way hinges 20, and a folding ladder 10 as discussed in detail below.

The folding ladder 10 includes a first section 11 at a first end, a second section 13 at a second end, a third section 12 between the first section 11 and the second section 13, and a plurality of rungs 14 between two side rails 15 of each of the first, second and third sections 11, 13 and 12.

Each hinge 20 is disposed at one of two joining portions of the first section 11 and the third section 12 or one of two joining portions of the second section 13 and the third section 12.

The locking assembly 30 includes a tubular member 31 for allowing the side rail 15 of the folding ladder 10 to pass through, a concave keeper surface 33 formed on the tubular member 31, and a cam type actuator arm 32 configured to pivotably engage the concave keeper surface 33 to fasten the side rail 15 of the folding ladder 10 and the tubular member 31 together.

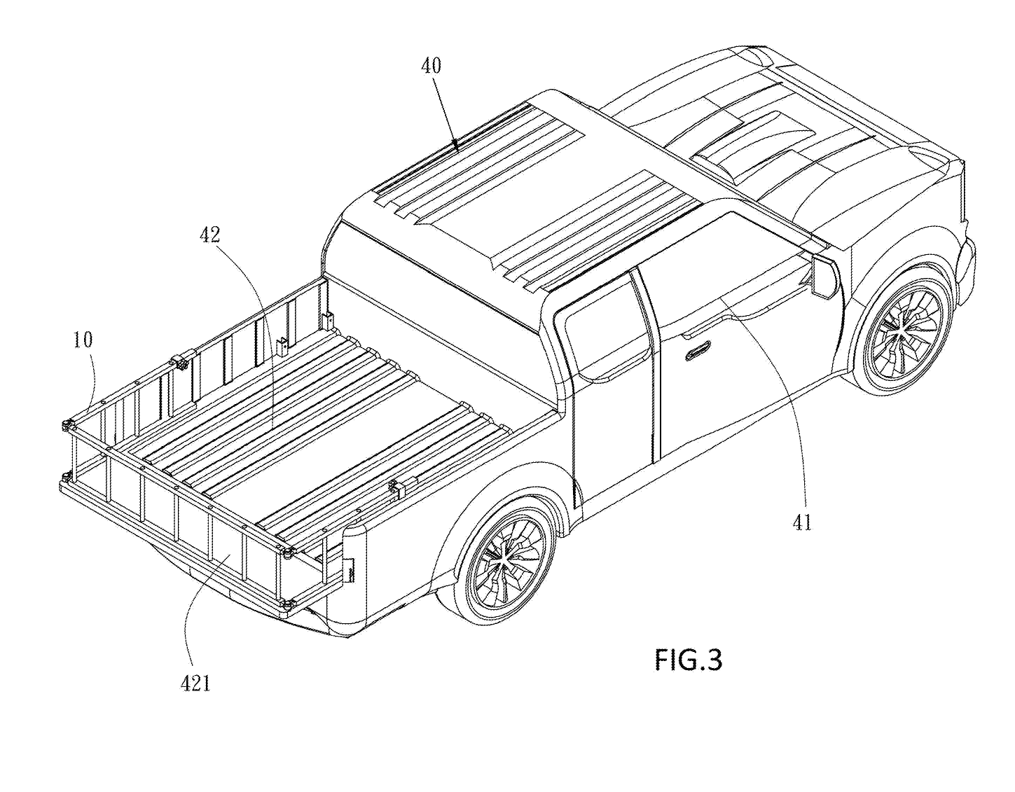

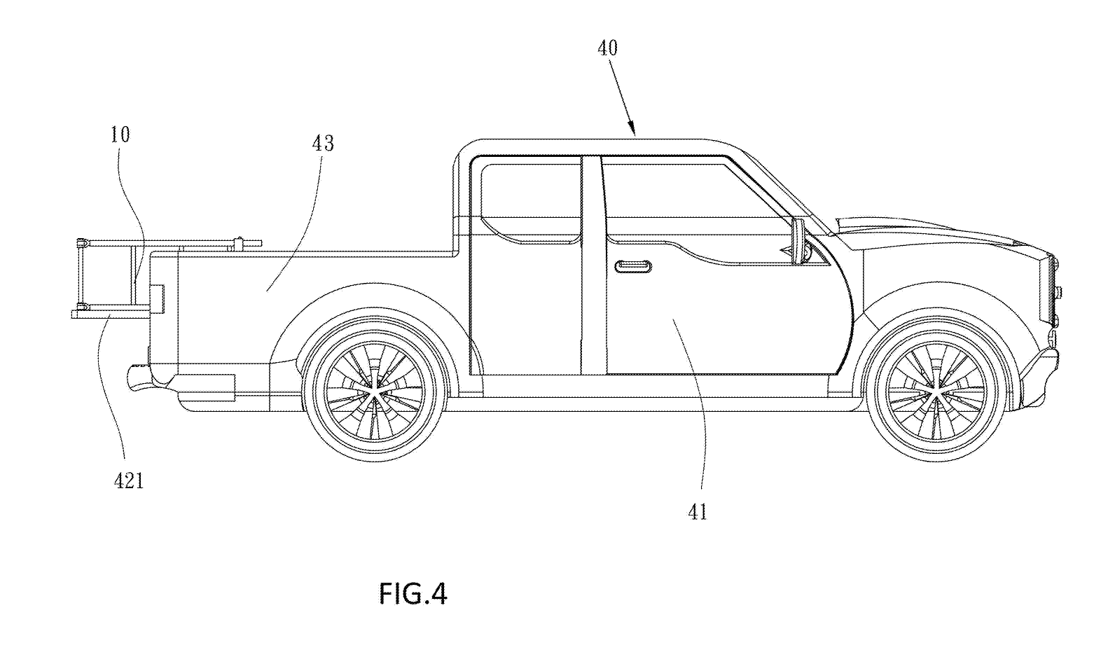

As shown in FIGS. 3 and 4, a first configuration of the folding ladder 10 is shown in which one side wall 43 is removed.

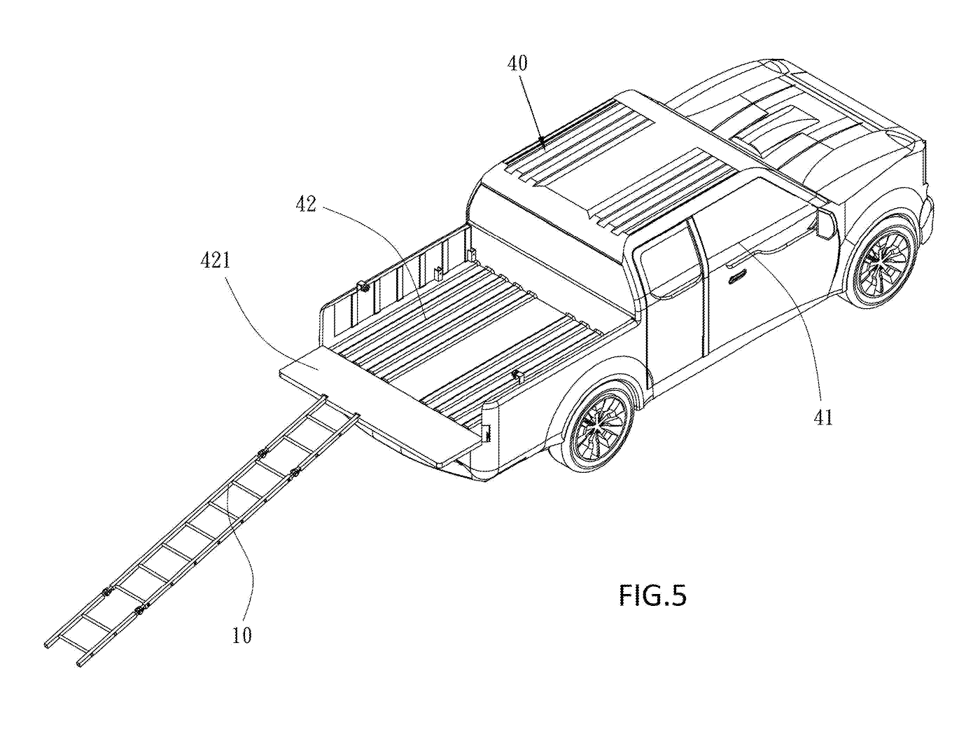

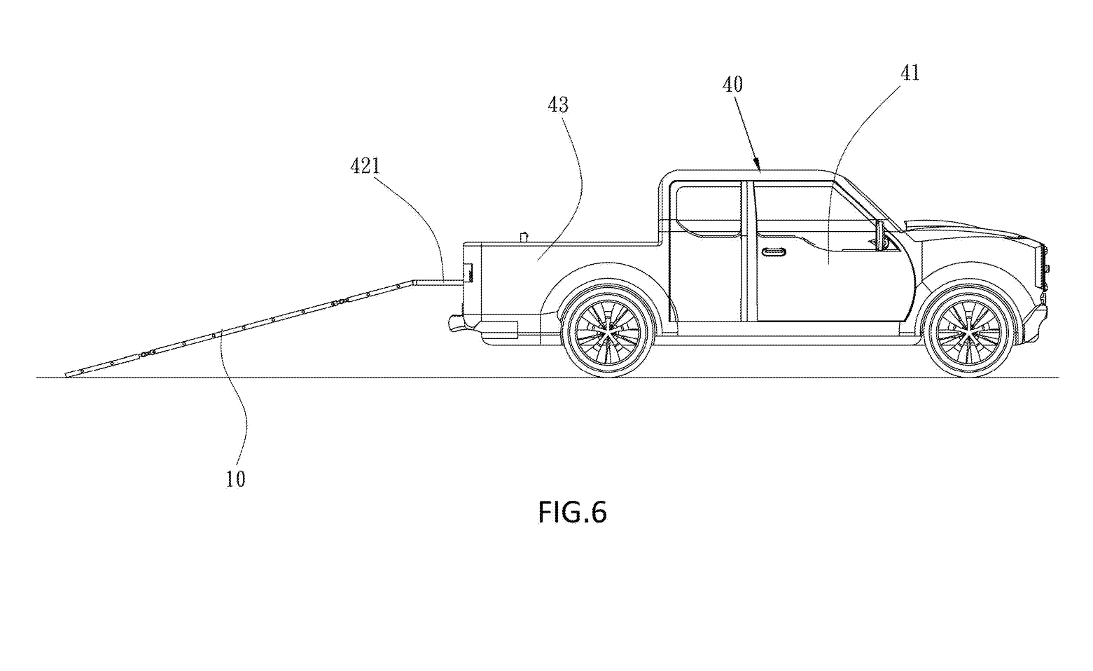

As shown in FIGS. 5 and 6, a second configuration of the folding ladder 10 is shown in which the folding ladder 10 is used as a ladder having one end secured to the tailgate 421 and the other end rested on the ground.

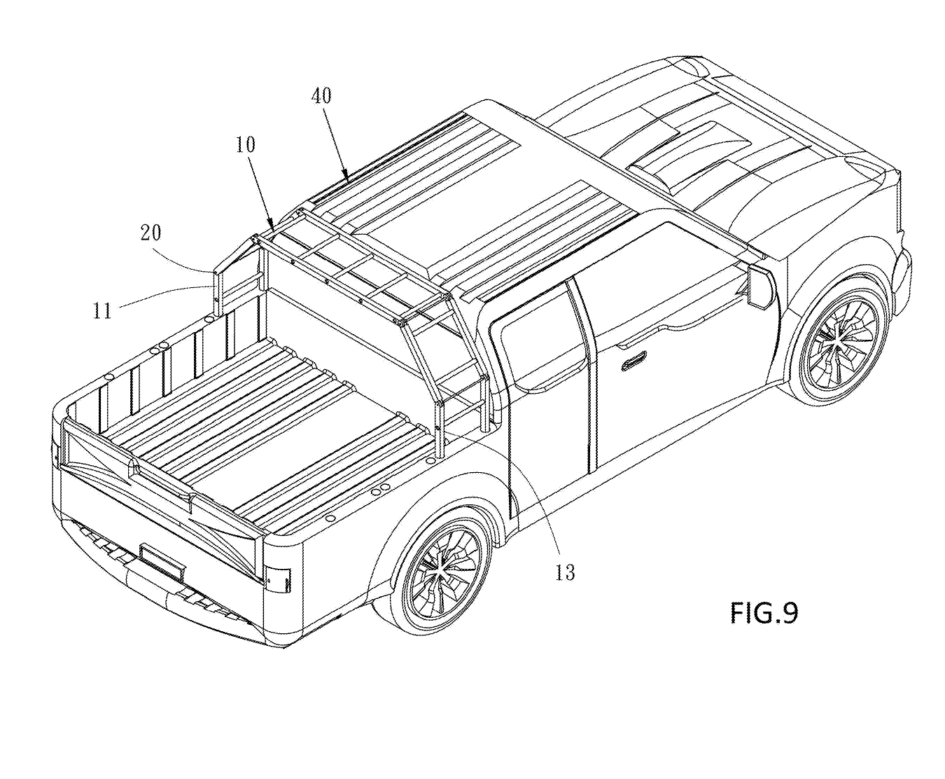

As shown in FIG. 9, a third configuration of the folding ladder 10 is shown in which the third section 12 has two pivotal end portions due to the provision of hinges 20.

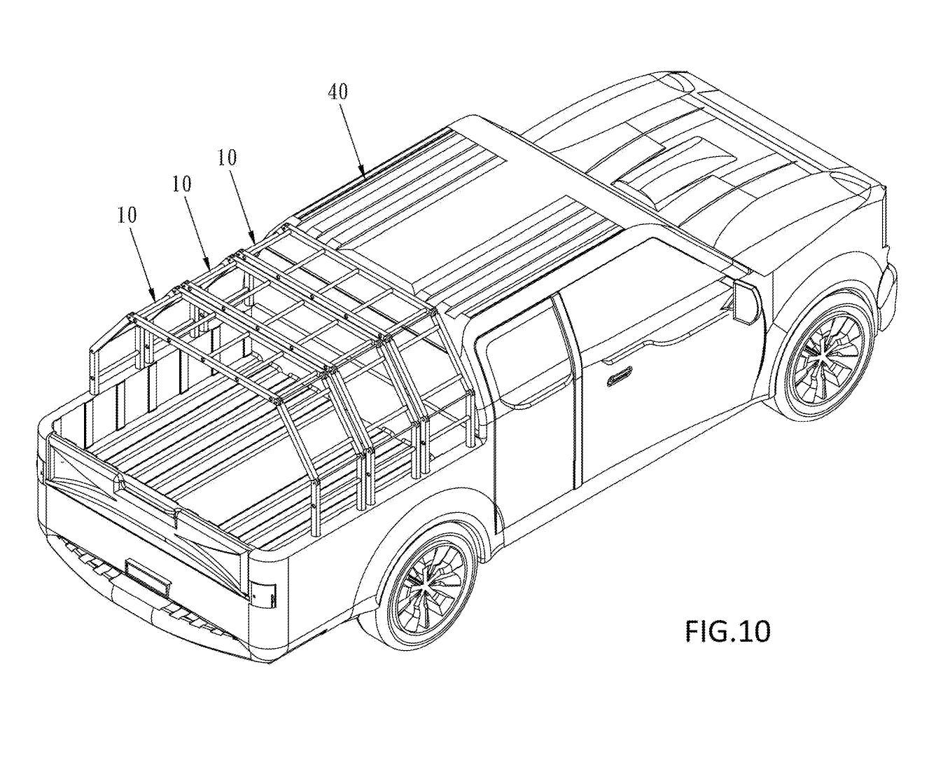

As shown in FIG. 10, a fourth configuration of the folding ladder 10 is shown in which three third sections 12 of the third configuration are provided parallel.

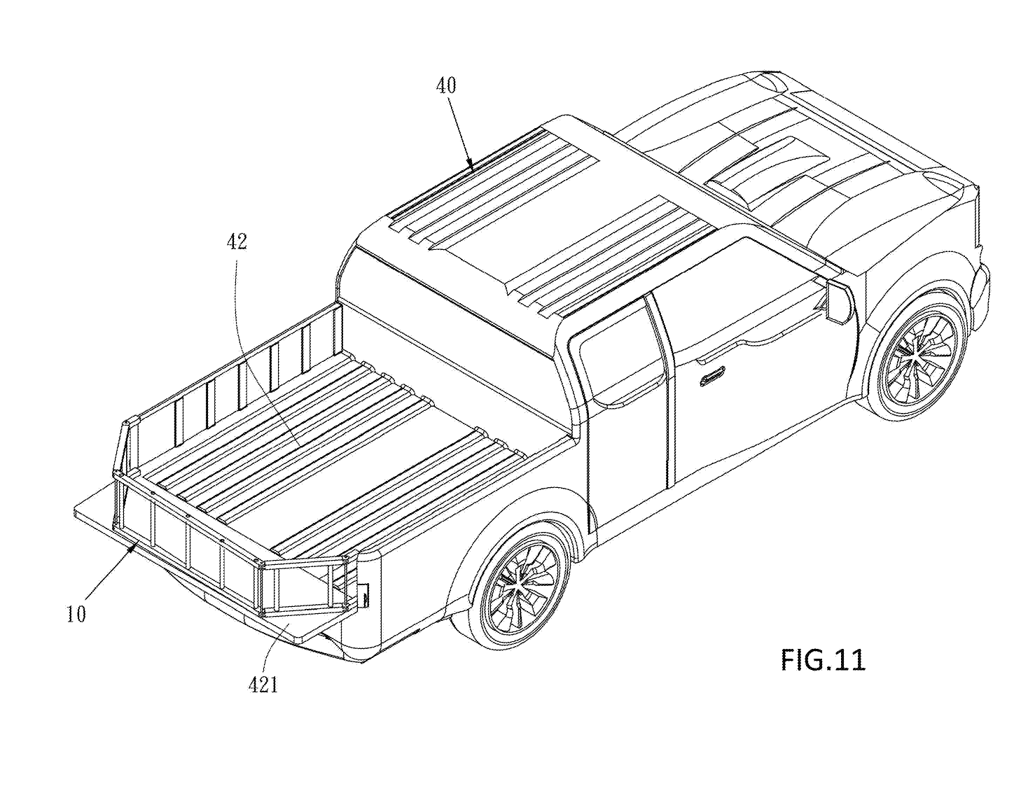

As shown in FIG. 11, a fifth configuration of the folding ladder 10 is shown in which the first section 11 is an acute angle with respect to the third section 12, and the third section 13 is an acute angle with respect to the third section 12.

While the invention has been described in terms of preferred embodiments, those skilled in the art will recognize that the invention can be practiced with modifications within the spirit and scope of the appended claims.

What is claimed is:

1. A pickup truck comprising:
a cab;
a tailgate;
a bed;
two side walls;
two sets of a plurality of locking assemblies disposed on the side walls respectively; and
a folding ladder including two side rails, a plurality of rungs, a first section at a first end, a second section at a second end, a third section between the first section and the second section, and a plurality of one-way hinges each disposed at one of two joining portions of the first section and the third section or one of two joining portions of the second section and the third section;
wherein each locking assembly includes a tubular member for allowing either side rail of the folding ladder to pass through, a concave keeper surface disposed on the tubular member, and a cam type actuator arm configured to pivotably engage the concave keeper surface to fasten the side rail of the folding ladder and the tubular member together.
